(19) United States
(12) Patent Application Publication
(10) Pub. No.: US 2009/0250322 A1
(43) Pub. Date: Oct. 8, 2009

(54) Belt conveyor

(76) Inventor: Todd G. Jager, Sioux City, IA (US)

Correspondence Address: THOMTE LAW OFFICE, L.L.C., 2120 S. 72ND STREET, SUITE 1111, OMAHA, NE, 68124, US

(21) Appl. No.: 12/082,012

(22) Filed: Apr. 8, 2008

(51) Int. Cl. B65G 23/04

(52) U.S. Cl. 198/835

(57) ABSTRACT

A belt conveyor which includes first and second vertically disposed side frame members. The side frame members are provided with a plurality of notches formed therein which are adapted to selectively receive portions of conveyor components. The conveyor components are quickly and easily installed into the conveyor and are quickly and easily removed therefrom for repair or replacement. The conveyor components may comprise idler rollers, belt shoes, belt lifters or spray bars.

### BACKGROUND OF THE INVENTION

1. Field of the Invention

This invention relates to a belt conveyor and more particularly a belt conveyor wherein the idler rollers, belt shoes, belt lifters, spray bars, etc. are quickly and easily secured to the side frames of the conveyor and which are quickly and easily removed therefrom for replacement or repair. All of the components described above may be snap-fitted into openings formed in the side frames with the openings being identical to one another. Further, the invention also particularly relates to idler rollers which are not only quickly and easily secured to and detached from the conveyor frame members but which are also easy to clean due to the relationship of central opening in the hub of the idler roller and the smaller diameter axle which extends therethrough.

2. Description of the Related Art

In the meat and food processing industries, belt conveyors are commonly used to convey the products from one location to another within the facility. Generally speaking, the conventional belt conveyors usually have a drive pulley at one end of the conveyor and an idler pulley at the other end thereof with those pulleys extending between a pair of horizontally spaced-apart frame members. The drive pulley is sometimes referred to as a drive roller, a drive sprocket or a head pulley. The idler pulley is sometimes referred to as an idler roller, an idler sprocket or a tail pulley. An endless conveyor belt extends around the drive pulley and the idler pulley to define an upper carry belt portion and a lower return belt portion. Usually, a plurality of idler rollers are mounted at the inside surfaces of the side frame members which support the carry and return belt portions of the conveyor. Frequently, the idler rollers are rotatably mounted on axles which are bolted or welded to the side frame members. Other conveyor components such as belt shoes, belt lifters, spray bars, etc. are also bolted or welded to the side frame members.

The means for mounting the idler rollers, belt shoes, belt lifters and spray bars make it difficult to replace the same if needed and make it difficult to adequately clean the conveyor and its components. Even though the side frame members are usually provided with “clean-out” openings formed therein, it is still difficult to properly clean the idler rollers, belt shoes, belt lifters, spray bar mounts, etc.

### SUMMARY OF THE INVENTION

The belt conveyor of this invention includes vertically disposed and horizontally spaced-apart first and second side frame members. The first side frame member has a first end, a second end, an upper end and a lower end with the second side frame member also having a first end, a second end, an upper and a lower end. A drive pulley is provided at one of the ends of the first and second side frame members and rotatably extends therebetween. An idler pulley is positioned at the other of the ends of the first and second side frame members and rotatably extends therebetween. An endless conveyor belt extends around the draft pulley and the idler pulley to define an upper carry belt portion and a lower return belt portion. Each of the first and second side frame members have a plurality of spaced-apart clean-out openings formed therein. A conveyor component is selectively removably snap-fitted into at least some of the openings. The conveyor components may comprise idler rollers, belt shoes, belt lifters, spray bars. etc. With respect to the idler rollers, the idler roller has an axle which has a substantially smaller diameter than the central opening of the hub of the pulley which receives the axle so that cleansing fluids may be directed into the area between the axle and the central opening in the hub to clean the same.

It is therefore a principal object of the invention to provide an improved belt conveyor.

A further object of the invention is to provide a belt conveyor wherein conveyor components thereof may be quickly and easily installed or removed therefrom.

Yet another object of the invention is to provide a unique way of mounting conveyor components such as idler rollers, belt shoes, spray bars or belt lifters between the side frame members of the conveyor by way of identical openings or notches formed in the side frame members.

Still another object of the invention is to provide a belt conveyor which enables components thereof to be mounted thereon such as belt shoes, spray bars, idler rollers or belt lifters between the side frame members of the conveyor.

Still another object of the invention is to provide a belt conveyor which enables components thereof to be mounted thereon without extensive modification of the conveyor.

These and other objects will be apparent to those skilled in the art.

### BRIEF DESCRIPTION OF THE DRAWINGS

FIG. 1 is a perspective view of the belt conveyor of this invention with a portion thereof cutaway to more fully illustrate the invention:

FIG. 2 is a side view of the conveyor of FIG. 1 with portions thereof cutaway to more fully illustrate the invention:

FIG. 3 is a partial exploded perspective view illustrating the ways that the idler roller of this invention may be attached to one of the side frame members of the conveyor:

FIG. 4 is a perspective view of the idler roller of this invention:

FIG. 4a is partial perspective view of the idler roller of FIG. 4 but taken from a different side thereof:

FIG. 5 is a sectional view of the idler roller of FIG. 4:

FIG. 6 is a perspective view of a belt slide utilized in the invention:

FIG. 7 is a perspective view of the belt slide of FIG. 6 but taken from a different angle:

FIG. 8 is a perspective view of a belt slide utilized in this invention:

FIG. 9 is a perspective view of the belt slide of FIG. 8 but taken from a different angle:

FIG. 10 is an exploded perspective view illustrating the manner in which a belt lifter may be utilized in this invention:

FIG. 11 is a perspective view of a portion of the means for securing one end of the belt lifter to a side frame member of the conveyor:

FIG. 12 is a perspective view of the retainer of FIG. 11 but taken from a different angle:

FIG. 13 is a partial perspective view illustrating the manner in which one end of the belt lifter is secured to the side frame member of the conveyor:

FIG. 14 is a sectional view of the view of FIG. 13 illustrating the manner in which one end of the belt lifter is secured to a side frame member of the conveyor; and

FIG. 15 is a partial side view of the conveyor which is partially cut away to illustrate the manner in which the belt lifter may lift the conveyor belt for cleaning purposes.

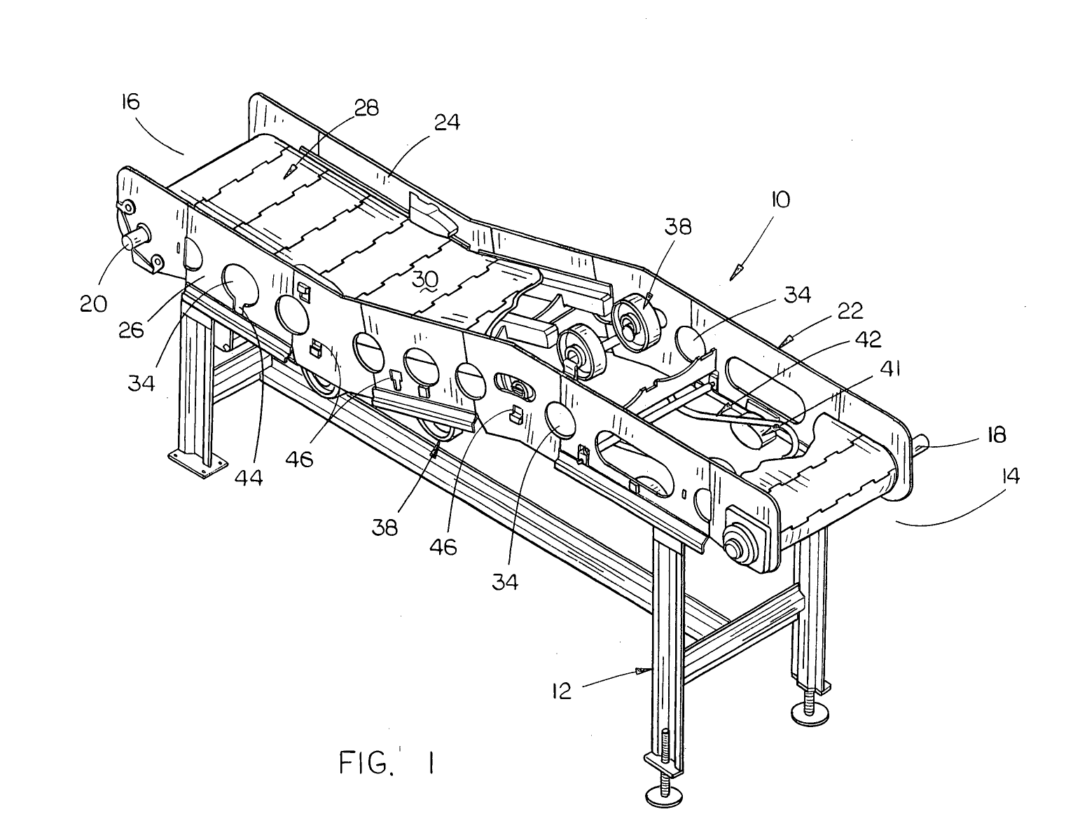

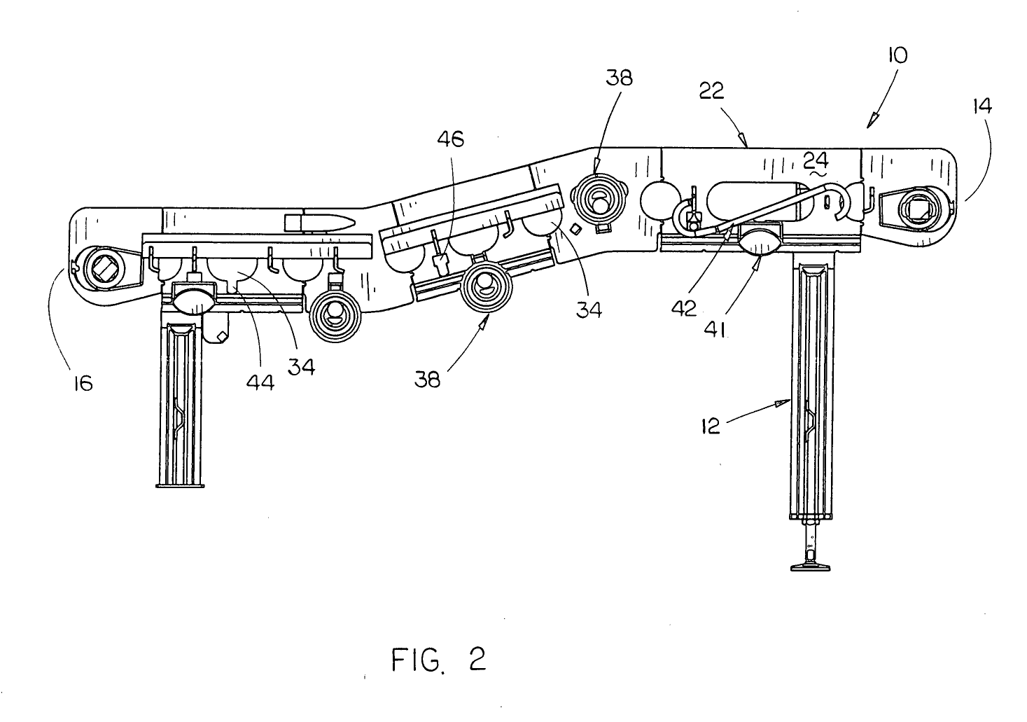

### DESCRIPTION OF THE PREFERRED EMBODIMENT

The numeral 10 refers to a conventional conveyor of the belt type which has been modified so as to be able to selectively removably and quickly attach conveyor components thereto and to quickly and easily remove the same should they need repair or replacement. The conventional conveyor 10 may be horizontally disposed or may be inclined as illustrated in the drawings. The conveyor 10 is supported upon a supporting leg structure 12 which does not form a part of this invention.

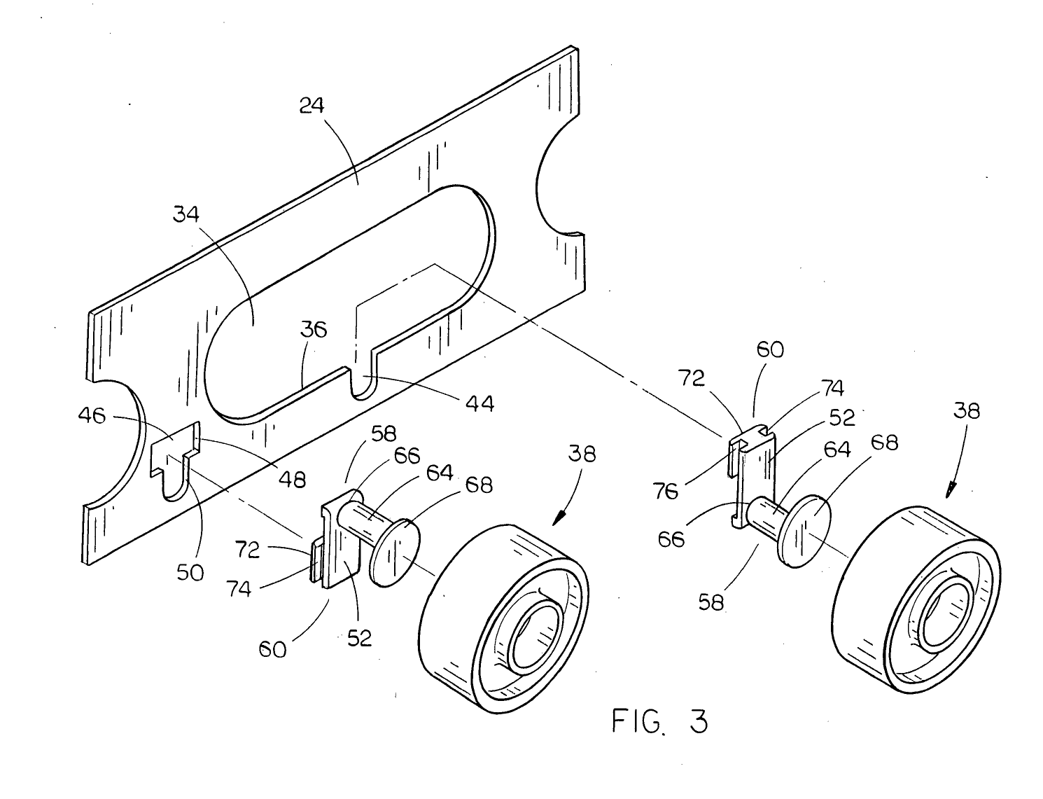

For purposes of description, conveyor 10 will be described as having a first end 14, and a second end 16 and which is adapted to have a drive pulley 18 rotatably mounted at one end thereof and an idler pulley 20 mounted at the other end thereof. Drive pulley 18 is conventionally driven by a conventional electric motor. Conveyor 10 includes a frame means 22 including a first side frame member 24 which is vertically disposed and a second side frame member 26 which is vertically disposed and which is horizontally spaced from side frame member 24 as seen in the drawings. An endless conveyor belt 28 extends around and between the shafts 18 and 20 so as to define an upper carry belt portion 30 and a lower return belt portion 32. Normally, the side frame members 24 and 26 will be provided with a plurality of “clean-out” openings 34 formed therein which are designed to permit a spray hose or the like to be inserted therethrough to spray the interior of the conveyor and the components therein with a cleaning solution. For purposes of description, each of the openings 34 will be described as having a lower edge portion 36 whether the opening is oval shaped or circular or any other shape (FIG. 3). The only difference between the conventional conveyor 10 and the invention described herein is the configuration of the idler rollers 38, belt shoes 40 and 41, belt lifter 42 or spray bar and the manner in which they are secured to the side frame members 24 and 26.

The lower edges 36 of the openings 34 are modified somewhat so as to have a generally rectangular notch 44 formed in the respective side frame member and which communicates with the opening 34 (FIG. 3). In some cases, when the openings 34 are not in the right position and it is desired to mount conveyor components at that location, a separate opening 46 is formed in the respective side frame member. Each of the openings 46 will have a generally horizontally disposed rectangular opening portion 48 and its upper end and a generally rectangular notch 50 extending downwardly therefrom. It is to either of the notches 44 or 50, which are identical, to which various components are selectively secured thereto in a “snapped-fitted” or “snap-in” manner as will be described hereinafter. In any event, when an opening 34 has been modified to create the notch 44 in one of the side frame members, an opening 34 in the other side frame member directly opposite to the modified opening 34 will also be modified to form notch 44. Likewise, when notch 50 is formed in one of the side frame members, another notch 50 will usually be formed in the other side frame member directly opposite to the first opening so that they will be in proper alignment with one another.

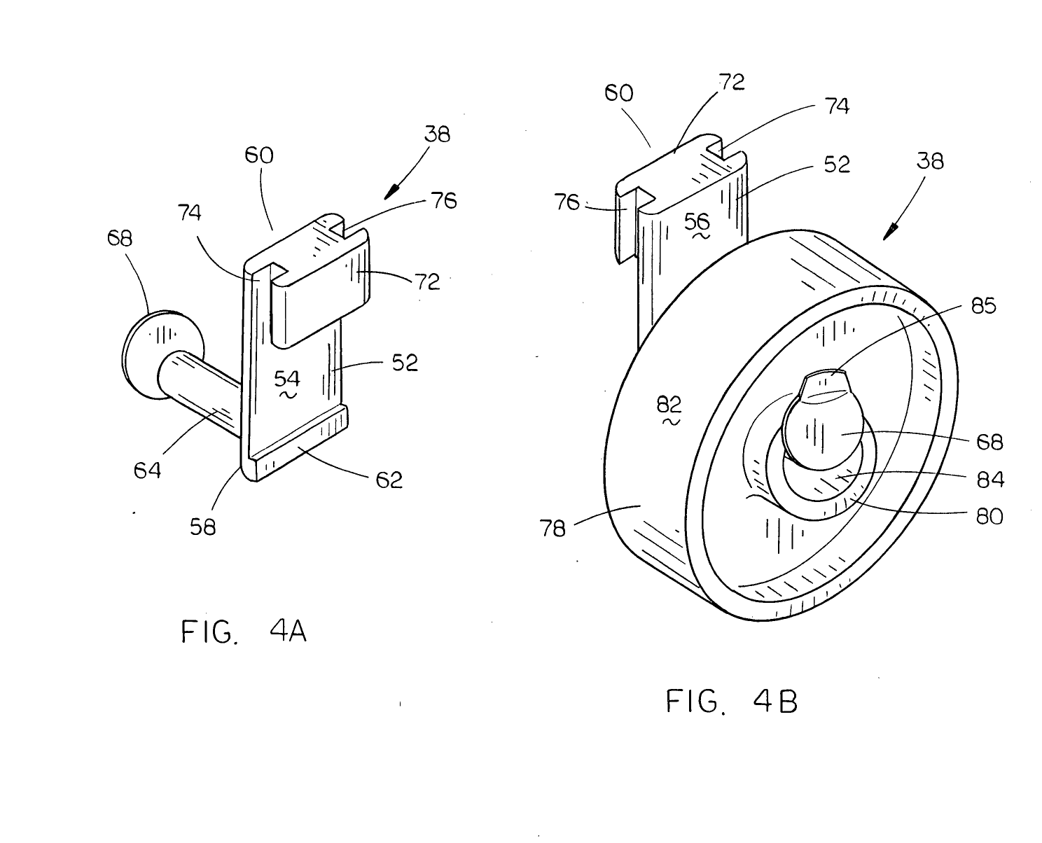

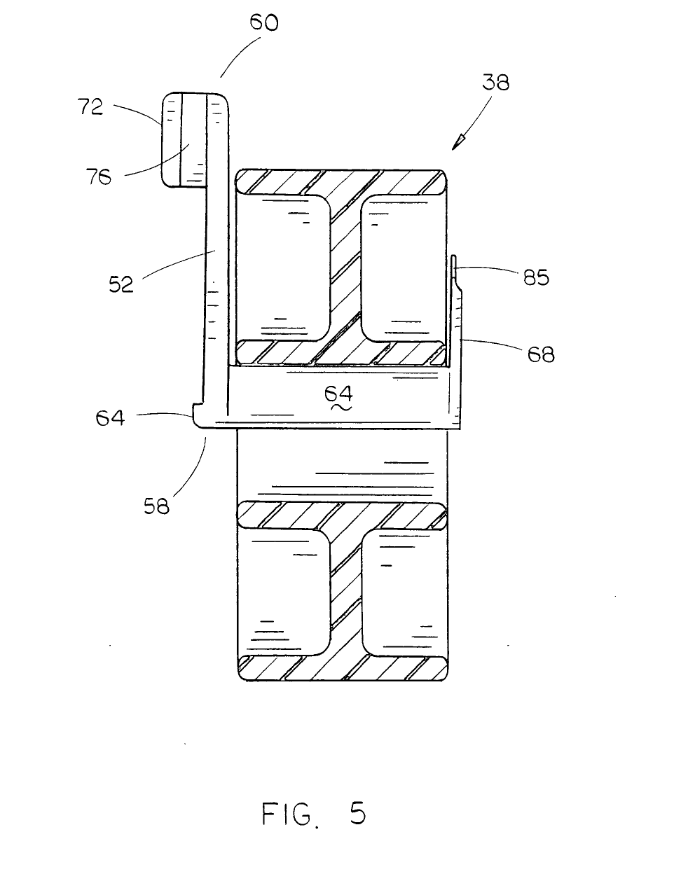

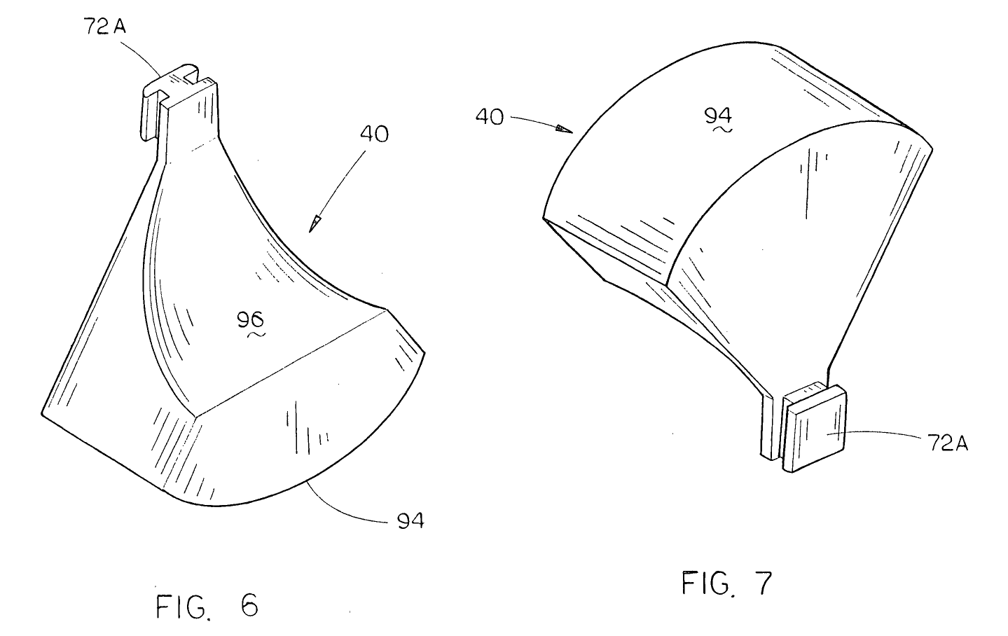

Idler roller 38 may be selectively removably positioned in either one of the notches 44 or 50. Idler roller 38, which is comprised of a suitable plastic material, includes a generally rectangular base portion or arm 52 having an outer surface 54, an inner surface 56 and ends 58 and 60. Rib 62 extends outwardly from outer surface 54 of base portion 52 at end 58 thereof. An elongated cylindrical axle 64 has its end 66 joined to base portion 52 at the inner surface thereof at end 58. A flat disk 68 is secured to the end 70 of axle 64 in an off-set manner as seen in FIG. 4A. The numeral 72 refers to a rectangular-shaped protrusion or body member which extends outwardly from outer surface 54 of base portion 52 at end 60. A pair of spaced-apart grooves 74 and 76 are formed in protrusion 72 which are parallel to the longitudinal axis of base portion 52.

Idler roller 38 includes a roller 78 having a central hub 80 and a peripheral surface or rim 82. Hub 80 has a central bore or opening 84 formed therein. Opening 84 has a diameter substantially larger than the diameter of axle 64 so that there is a “loose” fit therebetween. Disk 68 has a diameter slightly smaller than the diameter of bore 84. Axle 64 and disk 68 are extended through bore 84. At that time, a portion of the edge of disk 68 is deformed laterally at 85 so that the effective diameter of disk 68 is greater than the diameter of bore 84 so that roller 78 cannot disengage from axle 64.

Protrusion 72 may be inserted into notch 44 in one of two ways. In one way, base portion 52 extends upwardly from axle 64 as depicted at the right side of FIG. 3 and in the other way, base portion 52 extends downwardly from axle 64 as depicted at the left side of FIG. 3. In either case, if the idler roller is going to be mounted in notch 44, the protrusion 72 is initially positioned in an opening 34 with the grooves 74 and 76 being positioned directly above the notch 44. Idler roller 38 is then moved downwardly with respect to the associated side frame member so that the grooves 74 and 76 receive the edges of the frame member adjacent notch 44. The roller 78 is then in position so as to be able to engage either the inner surface of the return belt portion 32 if base portion 52 is extending downwardly from axle 64 or to engage the underside of carry belt portion 30 if base portion 52 extends upwardly from axle 64. In either case, rib 62 engages the inner surface of the associated side frame member to stabilize the assembly.

If the idler roller 38 is going to be inserted into a notch 50, protrusion 72 is pushed outwardly through the rectangular opening portion 48 of opening 46 and is then slidably moved downwardly into notch 50 with the grooves 74 and 76 receiving the side edges of the associated frame member adjacent the notch 50. Rib 62 engages the inside surface of the associated side frame member to stabilize the assembly.

The loose fit of the axle 64 in the bore 84 enables the axle 64 and the bore 84 to be properly cleaned since the cleaning fluid will be able to come into contact with the axle 64 and the bore 84. The idler roller 38 may be quickly installed in either of the notches 44 or 50 and may be quickly and easily removed therefrom by simply disengaging the protrusion 72 from the associated notch. Once removed, the axle 64 and base portion 52 of the idler rocker 38 may be disengaged from the roller 78 by simply breaking disk 68. The roller 78, if still serviceable, may be used on a replacement base portion 52 and axle 64 and reinstalled.

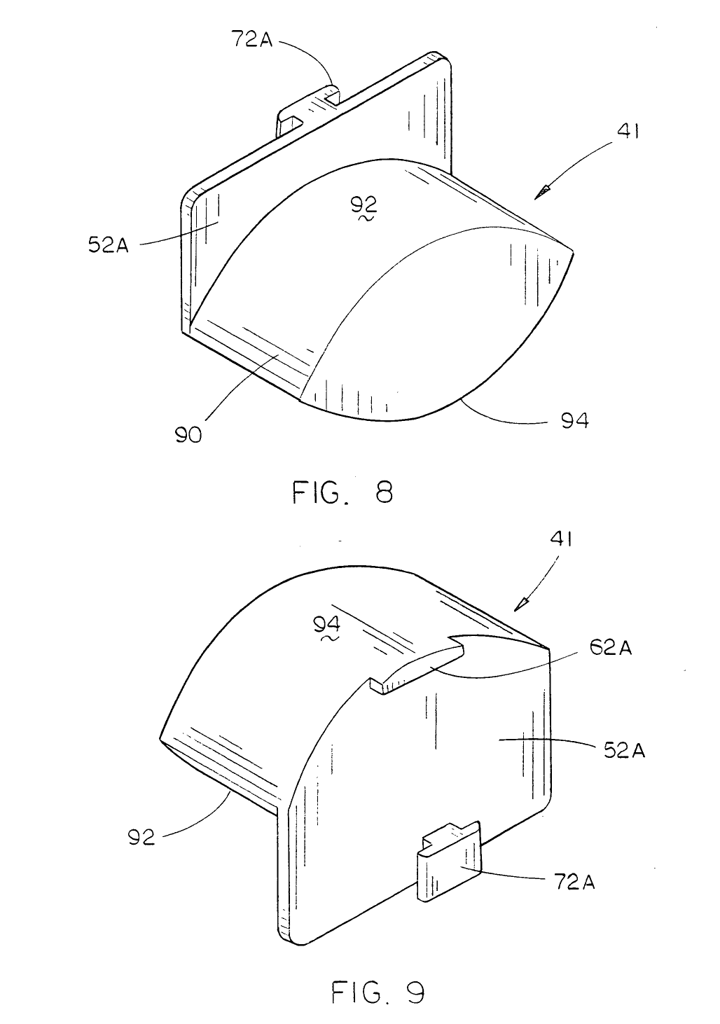

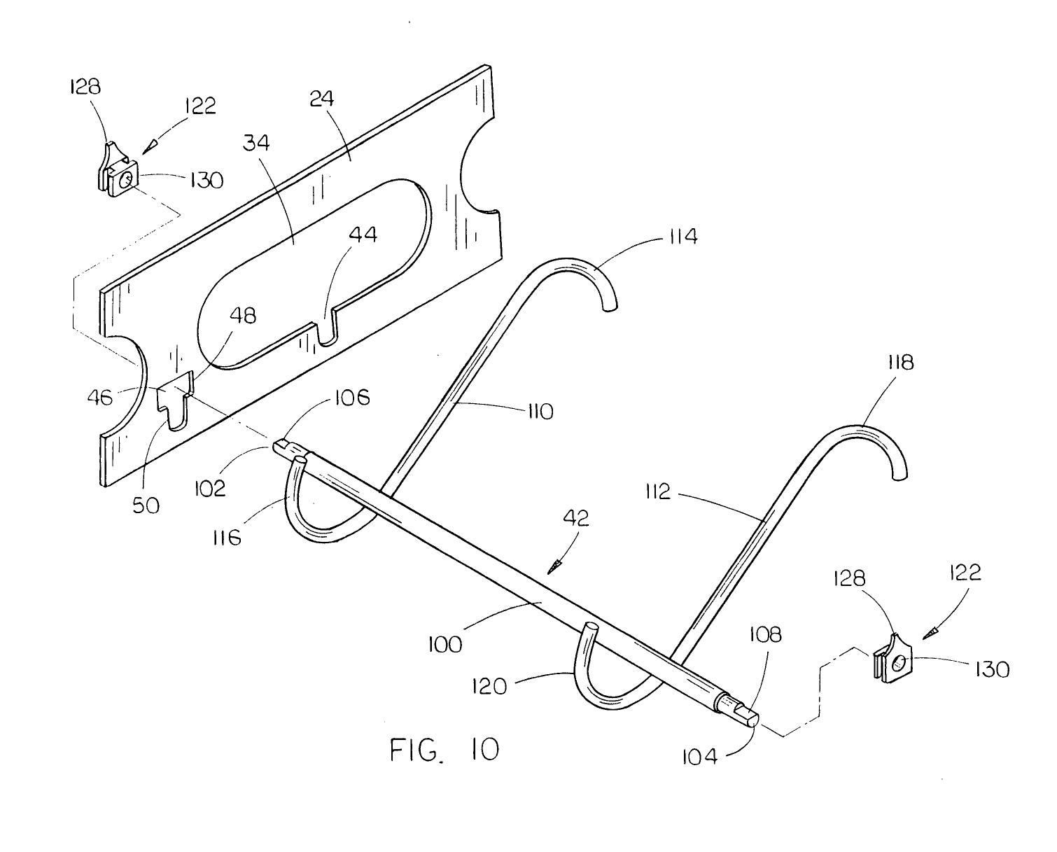

The numerals 40 and 41 refer to two different types of belt shoes which may be used with either the notches 44 or 50. Belt shoe 41 includes a base portion 52A and rib 62A which are substantially similar to base portion 52 and rib 62 on idler roller 38. Protrusion 72A on slide member 86 is substantially identical to protrusion 72 described hereinabove. The inner surface of base portion 52A has a body member 90 provided thereon which has arcuate belt engagement surfaces 92 and 94 formed thereon as seen in FIGS. 8 and 9. The protrusion 72A may be positioned in the notches 44 or 50 so as to be able to engage the inner surface of return belt portion 32 or the inner surface of carry belt portion 30 as desired. The belt shoe 41 is easily and quickly installed and quickly and easily removed from the associated side frame member. The belt shoe 41 is also easily cleaned.

Belt shoe 40 is generally similar to belt shoe 41 except that the arcuate surface 92 has been replaced with a generally transversely extending concave belt engagement surface 96 which is adapted to engage the inner surface of either the return belt portion 32 or the carry belt portion 30 as well as the side edge of the conveyor belt. The belt shoe 40 is quickly and easily installed and quickly and easily removed from the associated side frame member. The belt shoe 40 is also easily cleaned.

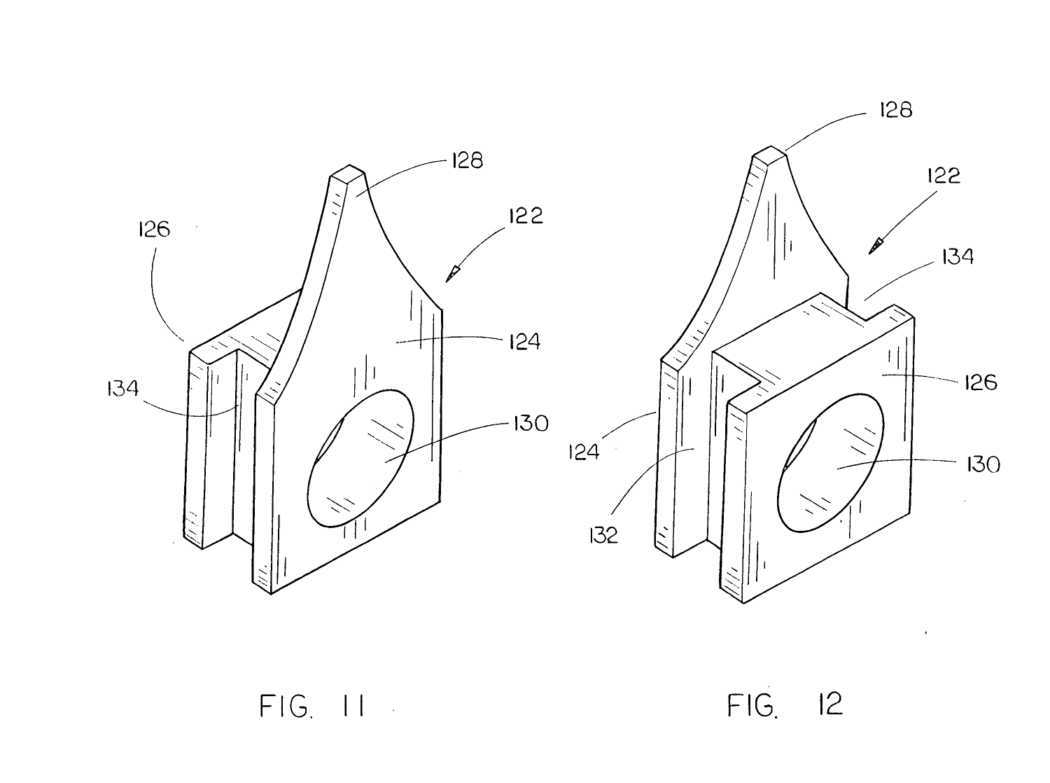

Belt lifter 42 includes an elongated rod or shaft 100 having ends 102 and 104 which have flats 106 and 108 formed therein respectively. A pair of generally S-shaped members 110 and 112 are welded to rod 100 as seen in FIG. 10 and have arcuate end portions 114, 116 and 118, 120 respectively. The numeral 122 refers to a retainer which is preferably comprised of a stainless steel material and which has an outer end 124 and an inner end 126. As seen in FIGS. 11 and 12, the outer end 124 of retainer of 122 has an upwardly projecting portion 128. Retainer 122 has a bore 130 extending therethrough and has a pair of vertically extending slots 132 and 134 formed therein which are adapted to receive the side edges of either the notches 44 or 50.

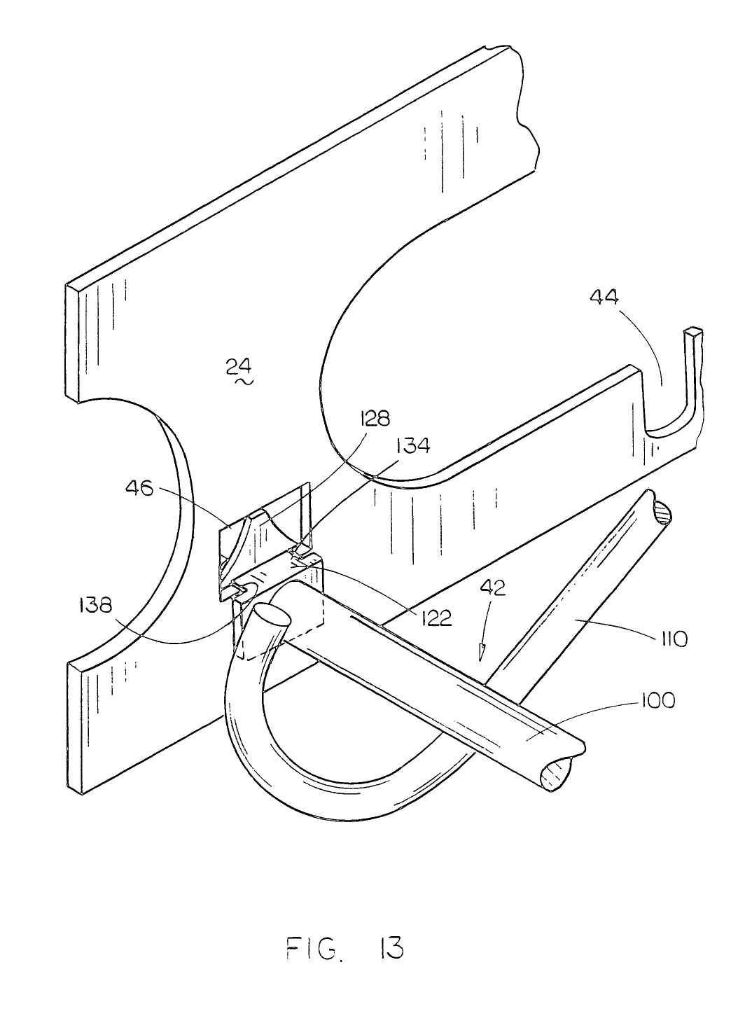

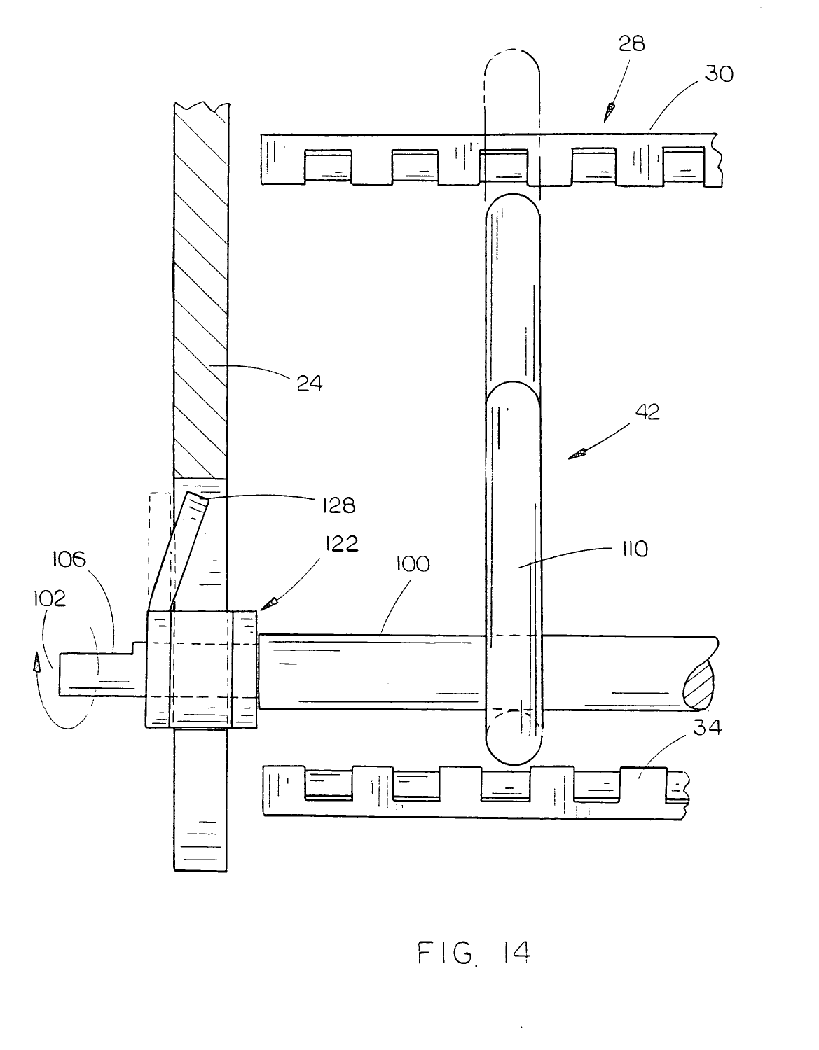

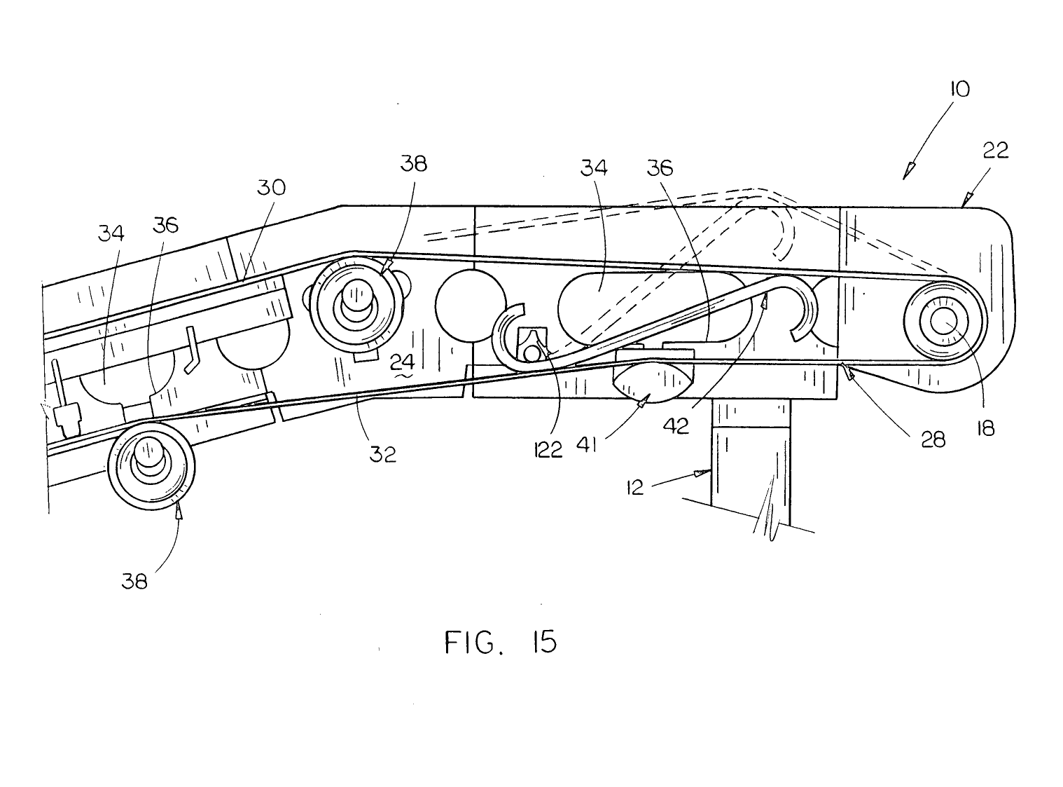

Assuming that the notches 50 are going to be used to mount the opposite ends of the rod 100 of belt lifter 42 to the opposite side frame members 24 and 26, the ends 102 and 104 of rod 100 are inserted through the openings 46 on the side frame members 24 and 26. Retainers 122 are then slipped onto the projecting outer ends 102 and 104 of rod 100 with the retainers 122 then being moved downwardly into the notches 50, as illustrated in FIG. 13. The upwardly projecting portions 128 of the retainers 122 are then bent inwardly as illustrated in FIGS. 13 and 14 so that the retainers 122 will remain in place in the notches 50. When it is desired to utilize the belt lifter to raise the conveyor belt 28 as illustrated in FIG. 15, a wrench or the like is attached to the plats 106 or 108 to enable the rod 100 to be rotated with respect to the retainers 122 so that the belt is raised to the position illustrated by broken lines in FIG. 15 to enable the inner surfaces of the conveyor belt to be cleaned. Normally, the conveyor belt 28 will be operated during the cleaning operation.

The belt lifter 42 may be easily and quickly mounted in the conveyor and may be quickly and easily removed therefrom. When it is desired to remove the belt lifter 42 for repair or replacement, the projections 128 on the retainers 122 are bent outwardly so that the retainers 122 may be removed from the notches 50 or from the notches 44 if that is where they have been installed.

The structure illustrated in FIG. 10 may be easily modified or substituted with a spray bar apparatus. Instead of providing a solid rod 100, the rod or shaft 100 may have an internal bore formed therein which communicates with a plurality of spray nozzles or spray openings formed in the rod or shaft 100. One end of the shaft or rod 100 would be placed in communication with a source of cleaning fluid under pressure so that the inner surfaces of the conveyor belt may be sprayed or cleansed.

Thus it can be seen that a novel conveyor belt system has been provided which enables conveyor components to be quickly and easily mounted to the side frame members of the conveyor frame and which may be easily removed therefrom for repair or replacement. It can also be seen that the means for mounting the conveyor components in the conveyor also permits the components thereof to be properly cleaned. Therefore it can be seen that the invention accomplishes at least all of its stated objectives.

1. A belt conveyor, comprising:
a first vertically disposed side frame member;
said first side frame member having a first end, a second end, an upper end and a lower end;
a second vertically disposed side frame member horizontally spaced from said first side frame member;
said second side frame member having a first end, a second end, an upper end and a lower end;
a drive pulley at one of said ends of said first and second side frame members and rotatably extending therebetween;
an idler pulley at the other of said ends of said first and second side frame members and rotatably extending therebetween;
an endless conveyor belt extending around said drive pulley and said idler pulley to define an upper carry belt portion and a lower return belt portion;
each of said first and second side frame members having a plurality of spaced-apart openings formed therein;
and a conveyor component selectively removably snap-fitted into at least some of said openings for engagement with said conveyor belt.

2. The belt conveyor of claim 1 wherein at least some of said conveyor components comprises an idler roller.

3. The belt conveyor of claim 1 wherein at least some of said conveyor components comprise belt shoes.

4. The belt conveyor of claim 3 wherein said belt shoes have an arcuate upper end which slidably engages and supports said return portion of said conveyor belt.

5. The belt conveyor of claim 3 wherein said belt shoes have an arcuate upper end which slidably engages and supports said carry portion of said conveyor belt.

6. The belt conveyor of claim 1 wherein at least some of said openings in said first and second side frame members have a generally rectangular notch portion extending downwardly therefrom into which a conveyor component is snap-fitted.

7. The belt conveyor of claim 1 wherein said conveyor component comprises a vertically disposed, generally rectangular-shaped base portion having first and second ends, and inner and outer sides, an elongated, cylindrically axle secured at one end thereof to one end of said base portion and extending transversely therefrom, an idler roller having a hub portion and a peripheral portion, said hub portion having a central opening formed therein which rotatably receives said axle, said axle having a diameter which is substantially less than the diameter of said central opening, a retainer at the other end of said axle which retains said idler roller on said axle, said base portion having a protruding member provided at its other end which is selectively slidably received by said opening.

8. The belt conveyor of claim 7 wherein a generally rectangular notch extends downwardly from at least some of said openings in said side frame members and wherein said protruding member is slidably received in said rectangular notch.

9. The belt conveyor of claim 8 wherein said protruding member is generally rectangular and is received by said rectangular notch.

10. The belt conveyor of claim 1 wherein said conveyor component engages the underside of said lower return belt portion of said conveyor belt.

11. The belt conveyor of claim 1 wherein said conveyor component engages the underside of said upper carry belt portion of said conveyor belt.

12. A belt conveyor, comprising:
a first vertically disposed side frame member;
said first side frame member having a first end, a second end, an upper end and a lower end;
a second vertically disposed side frame member horizontally spaced from said first side frame member;
said second side frame member having a first end, a second end, an upper end and a lower end;
a drive pulley at one of said ends of said first and second side frame members and rotatably extending therebetween;
an idler pulley at the other of said ends of said first and second side frame members and rotatably extending therebetween;
an endless conveyor belt extending around said drive pulley and said idler pulley to define an upper carry belt portion and a lower return belt portion;
each of said first and second side frame members having a plurality of spaced-apart openings formed therein;
and a conveyor component selectively removably snap-fitted into at least some of said openings.

13. The belt conveyor of claim 12 wherein said conveyor component comprises a belt lifter assembly positioned between said carry belt portion and said return belt portion.

14. The belt conveyor of claim 12 wherein said conveyor component comprises a spray bar assembly positioned between said carry belt portion and said return belt portion.

15. The belt conveyor of claim 13 wherein said belt lifter assembly has first and second ends which are selectively removably received in said openings in said first and second frame members and which extends therebetween.

16. The belt conveyor of claim 14 wherein said spray bar has first and second ends which are selectively removably received in said openings in said first and second frame members and which extends therebetween.

17. The belt conveyor of claim 12 wherein said conveyor component comprises an idler roller.

18. The belt conveyor of claim 12 wherein all of said openings into which said components are snap-fitted are identical.
